(19) United States
(12) Patent Application Publication
(10) Pub. No.: US 2011/0229170 A1
(43) Pub. Date: Sep. 22, 2011

(54) FIXING APPARATUS AND IMAGE FORMING APPARATUS

(75) Inventor: Yosuke SHIMIZU, Toyokawa-shi (JP)

(73) Assignee: Konica Minolta Business Technologies, Inc., Tokyo (JP)

(21) Appl. No.: 13/051,620

(22) Filed: Mar. 18, 2011

(30) Foreign Application Priority Data
Mar. 19, 2010 (JP) 2010-064108

(51) Int. Cl. G03G 15/20; G03G 21/20

(52) U.S. Cl. 399/45; 399/67; 399/334; 399/92; 399/69

(57) ABSTRACT

An excitation coil positioned along an axial direction of a fixing rotational body having a heat generating layer causes the heat generating layer to generate heat by electromagnetic induction. Magnetic flux shielding members positioned outside the excitation coil in a radial direction of the fixing rotational body cover at least one end of a maximum sheet passing region. A controller moves the magnetic flux shielding members along the excitation coil, and when a fed sheet has a width smaller than a width of the maximum sheet passing region, a center hole of the excitation coil is more widely covered. In a plan view, a circumference of each of the magnetic flux shielding members partially and obliquely crosses with the center hole in the axial direction of the fixing rotational body.

This application is based on an application No. 2010-64108 filed in Japan, the contents of which are hereby incorporated by reference.

### BACKGROUND OF THE INVENTION

(1) Field of the Invention

The present invention relates to an electromagnetic induction-heating type fixing apparatus and an image formation apparatus, and in particular to a technology for preventing overheat of a region where no recording sheet passes through using a small, light and low-cost configuration.

(2) Description of the Related Art

In recent years, there have been actively developed electromagnetic induction-heating type fixing apparatuses having low heat capacity, because of its high power efficiency. However, there has been a problem as follows. When recording sheets each having a small width (hereinafter, “small-sized sheets”) are continuously fed to the fixing apparatus, the temperature at a region where no recording sheet passes through (hereinafter, “non sheet passing region”) overheats. This is because, while heat at a region where the recording sheets pass through (hereinafter, “sheet passing region)” is drawn by the small-sized sheets, heat at the non sheet passing region is not drawn by the small-sized sheets. Accordingly, the temperature at the non sheet passing region is increased, and in a case where recording sheets each having a large width (hereinafter, “large-sized sheets”) are passed through immediately after the continuous feed of the small-sized sheets, this temperature difference might cause several defects such as uneven fixation and failure of the apparatus.

In view of the above problem, there have been proposed the following technologies, for example.

(A) Japanese Patent Application Publication No. 2007-226126

As FIG. 10A shows, demagnetization coils 1003 are disposed at respective ends of a fixing member 1001 so as to cancel a magnetic flux generated by an excitation coil 1002 and reduce magnetic flux density in a non sheet passing region. Connection state of each of the demagnetization coils 1003 is switched by detecting the temperature of the non sheet passing region or receiving a size of a sheet before the sheet is fed.

(B) Japanese Patent Application Publication No. 2001-235962

As FIG. 10B shows, a plurality of excitation coils 1011 are disposed in a longitudinal direction of a fixing member 1012. Each of the plurality of excitation coils 1011 have an effective length of heating that is shorter than a width of a maximum sheet passing region. Conducting state of each of the plurality of excitation coils 1011 is switched according to a size of a recording sheet or the temperature of a non sheet passing region.

(C) Japanese Patent Publication No. 4264086

As FIG. 10C shows, magnetic flux shielding members 1021a that are integrated with a core 1021 are disposed on a magnetic flux passage extending from an excitation coil 1024 to a fixing member 1028. By shielding a magnetic flux by rotating the core 1021 according to a size of a recording sheet or the temperature of a non sheet passing region, a heating range of the fixing member 1028 is switched.

However, according to the conventional technology (A), a demagnetization region greatly depends on a shape of the demagnetization coils 1003. In order to support various sizes of recording sheets, the proportional number of the demagnetization coils 1003 has to be disposed. This causes an increase in cost and size of the apparatus.

According to the conventional technology (B), in vicinity to joints of the plurality of excitation coils 1011, magnetic fluxes generated by adjacent excitation coils interfere with each other. This causes uneven temperature distribution of the fixing member 1012 in an axial direction thereof (in a direction perpendicular to a direction in which a sheet is conveyed). For example, as FIG. 7B shows, in a case of heating the maximum sheet passing region, in vicinity to the joints of the plurality of excitation coils 1011, the temperature of the fixing member might decrease.

According to the conventional technology (C), since the heating range of the fixing member 1028 is switched by only whether the magnetic flux shielding members 1021a are provided or not, it is impossible to flexibly support various sizes of recording sheets. Also, since the magnetic flux shielding members 1021a and the core 1021 are integrated, it is difficult to dissipate heat. Accordingly, due to overheat of the magnetic flux shielding members 1021a, surrounding members or the magnetic flux shielding members 1021a per se might be deteriorated or broken due to heat.

As described above, the above conventional technologies have various problems as it is impossible to sufficiently prevent overheat of the non sheet passing region or there is a negative effect that the apparatus increases in size.

### SUMMARY OF THE INVENTION

The present invention has been achieved in view of the above problems, and aims to provide a fixing apparatus and an image formation apparatus that prevent failure of the fixing apparatus by effectively controlling overheat of a non sheet passing region, produce no negative effect such as uneven temperature distribution or low heating efficiency, and contribute to reduction in size, weight and cost with a simplified configuration.

In order to achieve the above aim, the fixing apparatus pertaining to the present invention is a fixing apparatus that fixes sheets of various sizes comprising: a fixing rotational body that includes a heat generating layer; an excitation coil having a center hole, is positioned along an axial direction of the fixing rotational body, and is configured to generate a magnetic flux and cause the heat generation layer to generate heat by electromagnetic induction so as to heat the fixing rotational body; magnetic flux shielding members that are positioned outside the excitation coil in a radial direction of the fixing rotational body so as to cover the center hole at a position corresponding to at least one of ends of a maximum sheet passing region of the fixing rotational body in the axial direction, and configured to be movable along the excitation coil; and a controller that is configured to move the magnetic flux shielding members such that when a fed sheet has a smaller width, the center hole of the excitation coil is more widely covered, wherein when a fed sheet has a width smaller than a width of the maximum sheet passing region, a part of a circumferential edge of each of the magnetic flux shielding members in a plan view obliquely crosses with the center hole in the axial direction of the fixing rotational body.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows a main structure of an image forming apparatus pertaining to an embodiment of the present invention;

FIG. 2 is a cross-sectional view of a main structure of a fixing apparatus 115;

FIG. 3 is a cross-sectional view of a layer structure of a fixing belt 206;

FIG. 4 is a perspective view of major components of the fixing apparatus 115;

FIG. 5A is a cross-sectional view of the major components of the fixing apparatus 115 and shows a situation in which magnetic flux shielding members 215 do not shield a magnetic flux that passes through a center core 209, and FIG. 5B is a cross-sectional view of the major components of the fixing apparatus 115 and shows a situation in which the magnetic flux shielding members 215 shield a magnetic flux that passes through the center core 209;

FIG. 6 is a schematic plan view showing a positional relationship between the magnetic flux shielding members 215 and the center core 209;

FIG. 7A shows temperature distribution of the fixing belt 206 in a width direction with regard to two recording sheets of different sizes pertaining to a present embodiment, and FIG. 7B shows temperature distribution of the fixing belt 206 in a width direction with regard to two recording sheets of different sizes pertaining to a conventional technology;

FIG. 8 explains a structure for moving the magnetic flux shielding members 215;

FIG. 9A shows an example of a structure for cooling the magnetic flux shielding members 215 where the air is supplied from one of two ends of a fixing roller 202 in an axial direction thereof, and FIG. 9B shows an example of a structure for cooling the magnetic flux shielding members 215 where the air is supplied from openings of main cores 213 that are rib-like; and

FIGS. 10A-C each show examples of main structures of fixing apparatuses pertaining to a conventional technology.

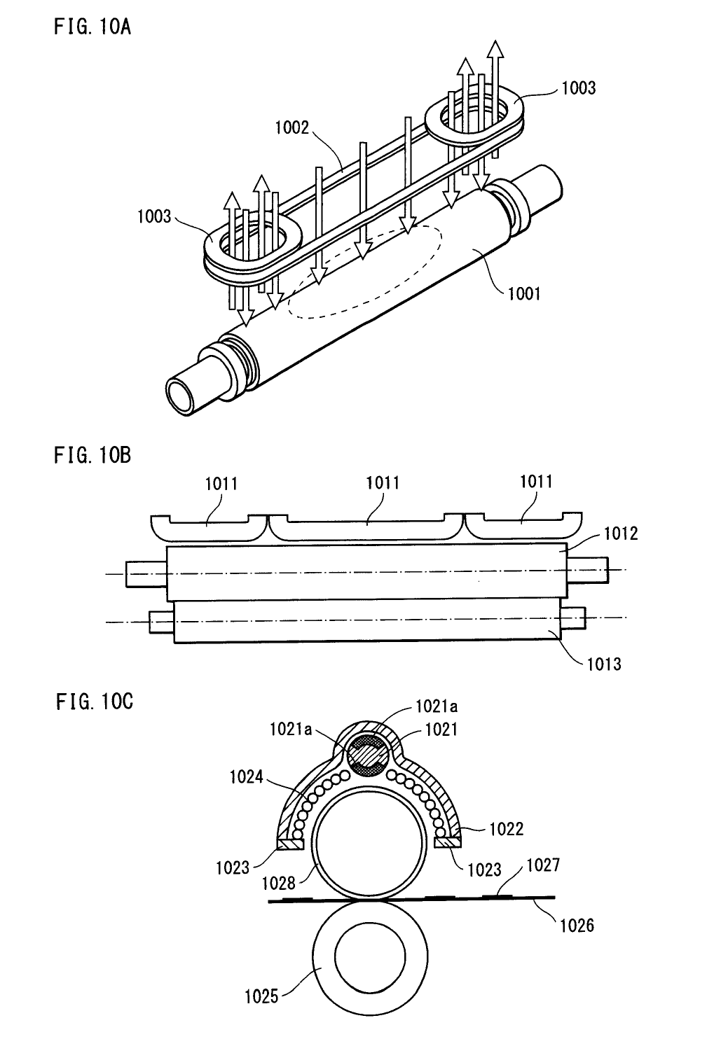

### DESCRIPTION OF THE PREFERRED EMBODIMENT

An embodiment of a fixing apparatus pertaining to the present invention is described below with reference to the drawings, taking an image forming apparatus as an example.

### [1] Structure of Image Forming Apparatus

First, there is an explanation of an image forming apparatus pertaining to the present embodiment.

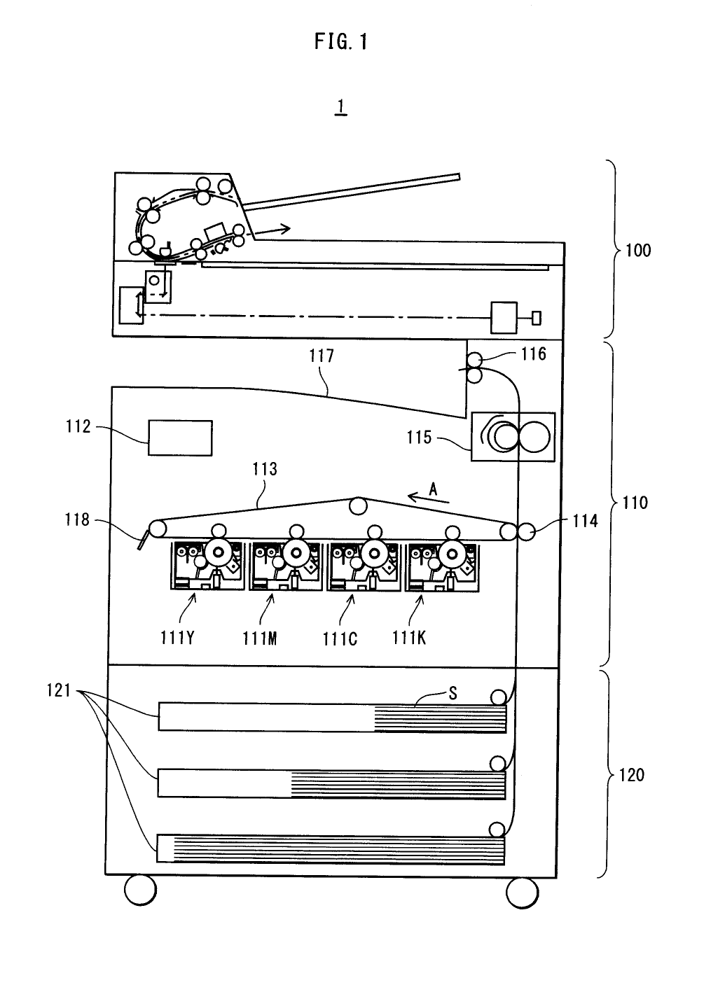

FIG. 1 shows a main structure of the image forming apparatus pertaining to the present embodiment. As FIG. 1 shows, an image forming apparatus 1 includes a document reader 100, an image forming section 110 and a feeder 120. The document reader 100 optically reads a document and forms image data.

The image forming section 110 includes image forming units 111Y-111K, a controller 112, an intermediate transfer belt 113, a pair of secondary transfer rollers 114, a fixing apparatus 115, a sheet discharge roller 116, a sheet discharge tray 117 and a cleaner 118.

The image forming units 111Y-111K form toner images in yellow (Y), magenta (M), cyan (C), and black (K) respectively under the control of the controller 112. The toner images are electrostatically transferred (primarily transferred) onto the intermediate transfer belt 113 so as to be superimposed. The intermediate transfer belt 113 is an endless rotational body that is rotated in a direction of an arrow A, and conveys the toner images to a secondary transfer position.

The feeder 120 includes feeding cassettes 121 that each store therein recording sheets S according to size and feed the recording sheets S to the image forming section 110. The fed recording sheets S are conveyed to the secondary transfer position in parallel with the intermediate transfer belt 113 that conveys the toner images.

The pair of secondary transfer rollers 114 electrostatically transfer (secondarily transfer) onto the recording sheets S, the toner images that have been transferred onto the intermediate transfer belt 113. The recording sheets S onto which the toner images have been transferred are conveyed to the fixing apparatus 115.

The fixing apparatus 113 is an electromagnetic induction-heating type fixing apparatus, which heats and fuses the toner images onto the recording sheets S. The recording sheets S onto which the toner images have been fused are discharged on the sheet discharge tray 117 by the sheet discharge roller 116.

### [2] Structure of Fixing Apparatus 115

Next, there is an explanation of a structure of the fixing apparatus 115.

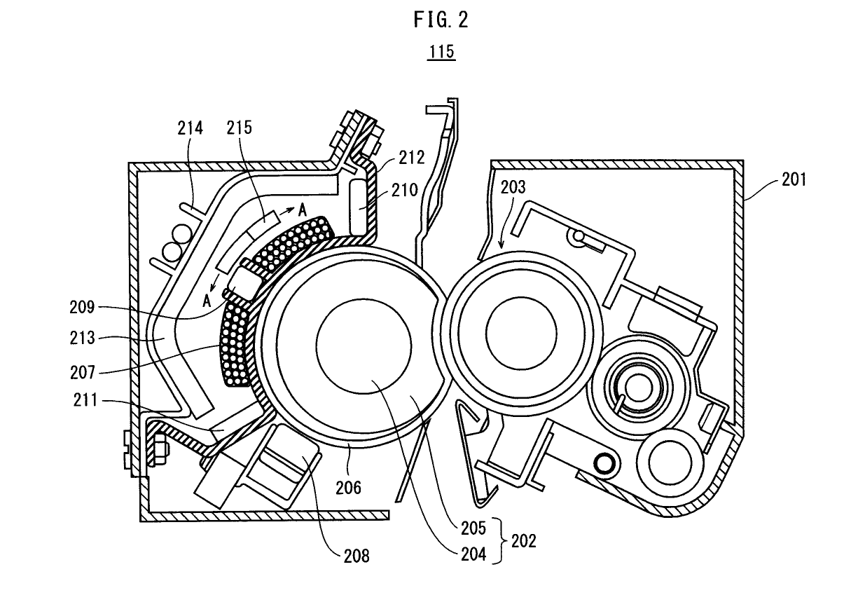

FIG. 2 is a cross-sectional view of a main structure of the fixing apparatus 115. As FIG. 2 shows, the fixing apparatus 115 has a fixing roller 202 and a pressurizing roller 203 that are disposed parallel with each other at a predetermined interval inside a housing 201. The pressurizing roller 203 is rotated by a driving motor that is not illustrated. The fixing roller 202 includes a shaft center 204, and an elastic layer 205 that is made of materials such as silicone sponge and formed around a circumferential surface of the shaft center 204.

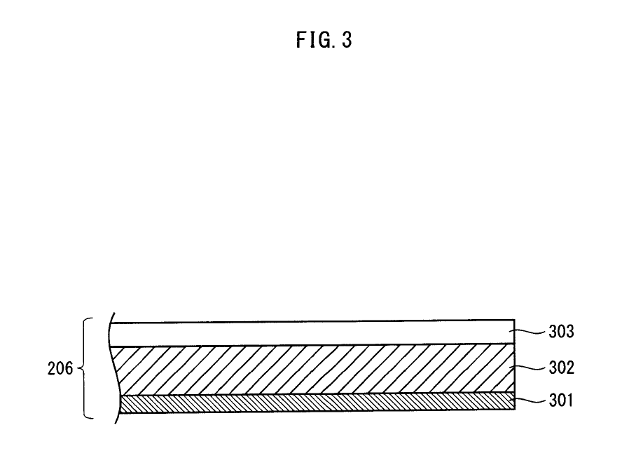

A fixing belt 206 is freely fit around a circumferential surface of the fixing roller 202. As FIG. 3 shows, the fixing belt 206 is formed, from a layer that is nearest to the circumferential surface of the fixing roller 202, with three layers including a metal heat generating layer 301, an elastic layer 302 and a mold release layer 303. The metal heat generating layer 301 is formed of an Ni electroformed sleeve, and generates heat by electromagnetic induction by an alternating magnetic flux generated by an excitation coil 207.

The pressurizing roller 203 is pressed against the fixing roller 202 by a pressing mechanism that is not illustrated. This mainly distorts the elastic layer 205 of the fixing roller 202 so that a nip width that is necessary for fixation is obtained.

Moreover, in vicinity to the circumferential surface of the fixing roller 202, an infrared sensor 208 is disposed. The infrared sensor 208 that is out of contact with the fixing roller 202 detects a signal indicating the surface temperature of substantially a central part of the circumferential surface in an axial direction thereof, and then transmits the detected signal. The controller 112 receives the detected signal and controls power distribution to the excitation coil 207 so that the temperature of the fixing roller 202 is controlled to be a predetermined value.

The excitation coil 207 and the center core 209 and hem cores 210 and 211 are held by a coil bobbin 212, and main cores 213 are held by a core holding member 214. The excitation coil 207 can generate a magnetic flux with necessary density for heat generation of a part of the fixing belt 206, which has the same width as a width of the maximum sheet passing region.

The excitation coil 207 is held by the coil bobbin 212. The excitation coil 207 is connected to a high-frequency inverter that is not illustrated, and high-frequency power of 10-100 [kHz] and 100-2000 [w] is supplied to the excitation coil 207. Accordingly, the excitation coil 207 is preferably made by winding litz wires made of thin wires that are covered with heat-resistance resin and bundled together.

The main cores 213 are bent to be trapezoidal so as to cover the excitation coil 207, and held by the core holding member 214 in a direction parallel to the axial direction of the fixing roller 202 at a predetermined interval therebetween.

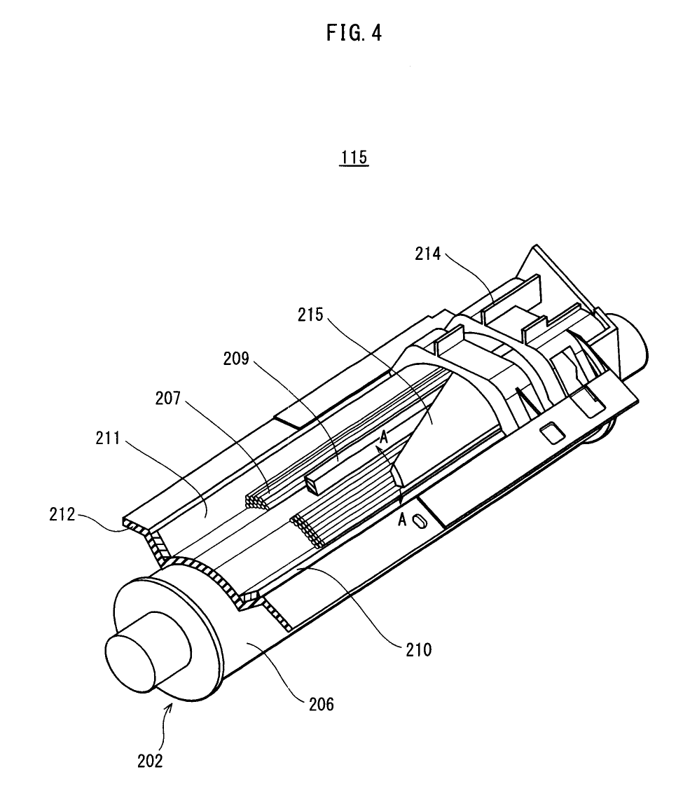

Also, the center core 209 and the hem cores 210 and 211 each have an elongated shape and are parallel to the axial direction of the fixing roller 202 (see FIG. 4), and are bonded to the coil bobbin 212 with use of a heat-resistant adhesive agent such as a silicone adhesive agent. The center core 209 uniformly conveys a magnetic flux generated by the excitation coil 207 to the fixing belt 206.

The coil bobbin 212 and the core holding member 214 are fixed by bolts and nuts at hem portions thereof. Alternatively, other components such as rivets may be used.

Also, the magnetic flux shielding members 215 for shielding a magnetic flux generated by the excitation coil 207 are disposed so as to be movable in and out of between the center core 209 and the main cores 213. The magnetic flux shielding members 215 each reciprocate in directions of arrows A by a drive mechanism that is not illustrated, so as to shield the magnetic flux that passes through the center core 209. In addition, the magnetic flux shielding members 215 are controlled to be out of contact with both the center core 209 and the main cores 213, regardless of whether the magnetic flux shielding members 215 are between the center core 209 and the main cores 213 or not.

FIG. 4 is a perspective view of major components of the fixing apparatus 115, which is partly cut in the middle in a longitudinal direction thereof for convenience of understanding of an internal structure of the fixing apparatus 115. As FIG. 4 shows, the magnetic flux shielding members 215 are each a plate-shaped member that is bent along the excitation coil 207. The magnetic flux shielding members 215 increase in width toward respective ends of the fixing roller 202 and decrease in width toward the center of the fixing roller 202.

The magnetic flux shielding members 215 may be made of, for example, Oxygen Free Copper (OFC) plate, and a surface of the OFC plate may be covered with a protective member. OFC generally indicates a 99.995 percent pure copper that does not include oxides.

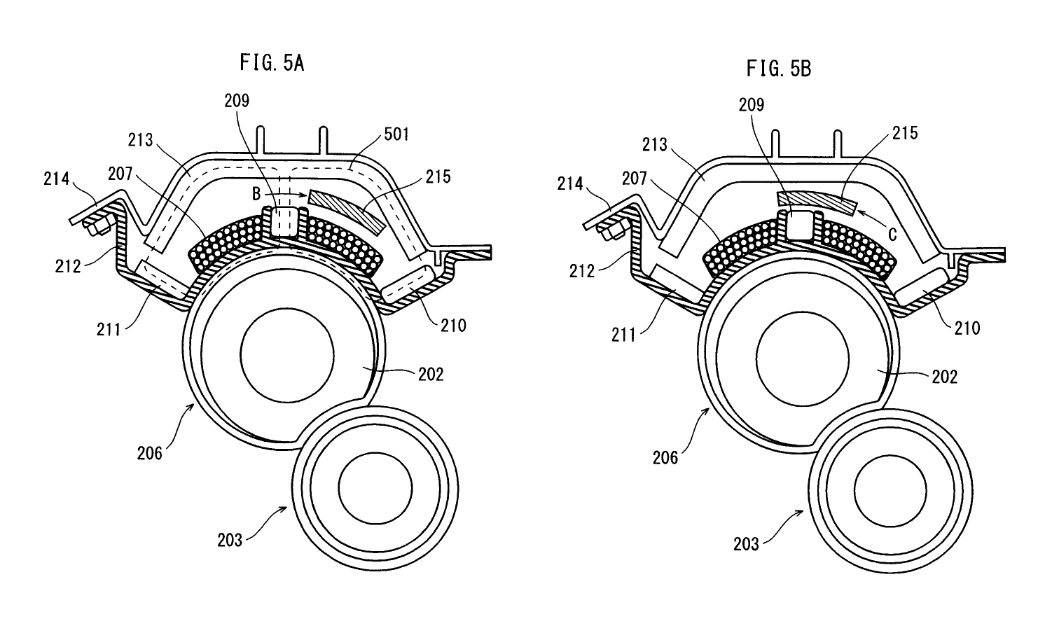

FIG. 5A is a cross-sectional view of the major components of the fixing apparatus 115 and shows a situation in which the magnetic flux shielding members 215 do not shield a magnetic flux that passes through the center core 209, and FIG. 5B is a cross-sectional view of the major components of the fixing apparatus 115 and shows a situation in which the magnetic flux shielding members 215 shield a magnetic flux that passes through the center core 209. As FIG. 5A shows, when the magnetic flux shielding members 215 move out in a direction of an arrow B, a magnetic flux 501 that passes through the center core 209 is not shielded. Accordingly, a corresponding position of the metal heat generating layer 301 of the fixing belt 206 generates heat by electromagnetic induction. On the other hand, as FIG. 5B shows, when the magnetic flux shielding members 215 move in a direction of an arrow C, the magnetic flux 501 that passes through the center core 209 is shielded. Accordingly, the corresponding position of the fixing belt 206 does not generate heat.

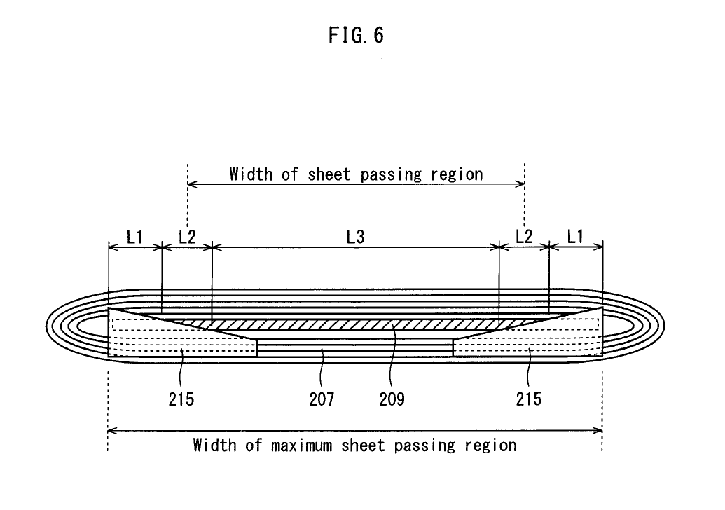

FIG. 6 is a schematic plan view showing a positional relationship between the magnetic flux shielding members 215 and the center core 209. As FIG. 6 shows, as viewed in a plan view, the magnetic flux shielding members 215 each have a side that obliquely crosses with the center core 209 in a longitudinal direction of the center core 209 (hereinafter, referred to simply as “oblique side”). The density of a flux that is generated by the excitation coil 207 and conveyed to the fixing belt 206 gradually changes along the longitudinal direction of the center core 209.

Also, since the magnetic flux shielding members 215 each have such an oblique side and reciprocate in the directions of arrows A in FIG. 2, the heating range can be freely increased and reduced in accordance with a size of a recording sheet in a width direction of the fixing belt 206.

Also, as FIG. 6 shows, as viewed in the plan view, the center core 209 is divided into three groups of areas: two first areas L1 that are completely covered with the magnetic flux shielding members 215; two second areas L2 that are partly covered with the magnetic flux shielding members 215; and one third area L3 that is not covered with the magnetic flux shielding members 215. A length of one of the two second areas L2 in the longitudinal direction of the center core 209 is preferably in a range of 5 to 30 mm.

According to the present embodiment, the second areas L2 are preferably formed by moving the magnetic flux shielding members 215 in the longitudinal direction of the center core 209, such that ends of a fed recording sheet pass through the respective second areas L2. Also, more preferably, each of the ends of the recording sheet passes through a substantially center portion of a corresponding one of the second areas L2.

With this structure, it is possible to prevent steep temperature gradient between the heating range and a non-heating range of the fixing belt 206.

In detail, when large-sized sheets each having a width of the maximum sheet passing region are passed through, the magnetic flux shielding members 215 is moved out of a magnetic flux passage that is formed by the excitation coil 207, the center core 209, the main cores 213, the hem cores 210 and 211 and the fixing belt 206. Then a magnetic flux is not shielded at all, and accordingly substantially whole of the fixing belt 206 is heated.

In the meantime, when small-sized sheets such as postcards or A5-sized sheets are passed through, heat generation of the non-heating range of the fixing belt 206 is suppressed as followings. The magnetic flux shielding members 215 are moved in so as to cross with a passage extending from the center core 209 to the main cores 213, which has the highest magnetic density in the above-mentioned magnetic flux passage.

In this case, as mentioned above, in vicinity to the boundary between the non sheet passing region and the sheet passing region, the magnetic flux shielding members 215 partly shield a magnetic flux and accordingly heat generation of the fixing belt 206 is not completely suppressed but reduced. If heat generation of the non sheet passing region is completely suppressed in vicinity to the boundary, too steep temperature gradient occurs in vicinity to the boundary. Accordingly, when an edge of a recording sheet covers the non-heating range, uneven glossiness or fixing faults might occur.

Since the magnetic flux shielding members 215 do not completely shield a magnetic flux in vicinity to the boundary, too steep temperature gradient does not occur. Accordingly, heat is not easy to escape from the sheet passing region to the non sheet passing region, and it is therefore possible to prevent uneven glossiness or fixing faults as above.

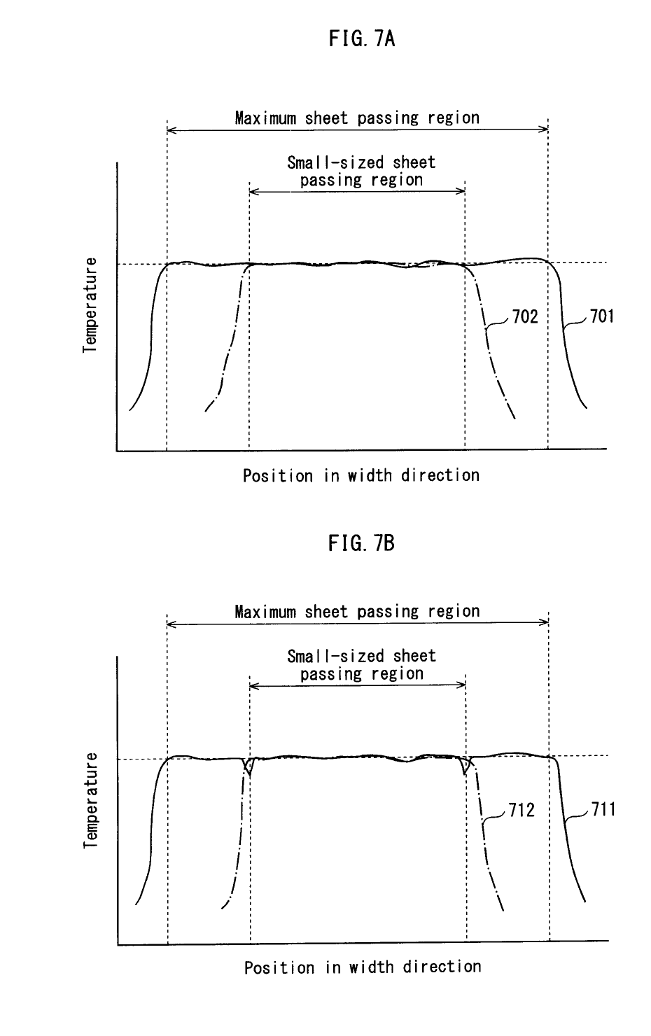

FIG. 7A shows temperature distribution pertaining to the present embodiment in a width direction of the fixing belt 206 on two recording sheets having different sizes with each other. FIG. 7B shows temperature distribution pertaining to the conventional technology in a width direction of the fixing belt 206 on two recording sheets having different sizes with each other. As FIG. 7A shows, it is possible to heat the maximum sheet passing region such that a surface temperature of the fixing belt 206 is substantially uniformed, regardless of whether the sheet passing region is heated for sheets each having a width of the maximum sheet passing region or the sheet passing region is heated for small-sized sheets.

That is, according to the present embodiment, by moving the magnetic flux shielding members 215 in accordance with a size (width) of a fed recording sheet, it is possible to maintain a part of the fixing belt 206 through which a recording sheet passes at the fixing temperature and prevent overheat of a part of the fixing belt 206 through which a recording sheet does not pass, regardless of a size of a recording sheet.

### [3] Modifications

As described above, the present invention has been described based on the embodiment. However, it is naturally understood that the present invention is not limited to the specific embodiment described above, and various modifications may be made as follows.

(1) Although a specific explanation has not been given in the embodiment above, a position of the magnetic flux shielding members 215 may be controlled as following.

For example, when image formation is performed, a size of a recording sheet is specified beforehand by a control panel or specified during print job.

Therefore, the magnetic flux shielding members 215 may be moved to an appropriate position in accordance with the specified size of the recording sheet such that the non sheet passing region is not overly heated.

Also, even when small-sized sheets are fed, overheat of the non sheet passing region does not occur as long as the sheets are not fed continuously. In view of this, a temperature sensor for detecting the temperature of the non sheet passing region may be provided, and when the sensor detects that the temperature of the non sheet passing region has reached a predetermined value, the magnetic flux shielding members 215 may be moved in to reduce magnetic density of the non sheet passing region.

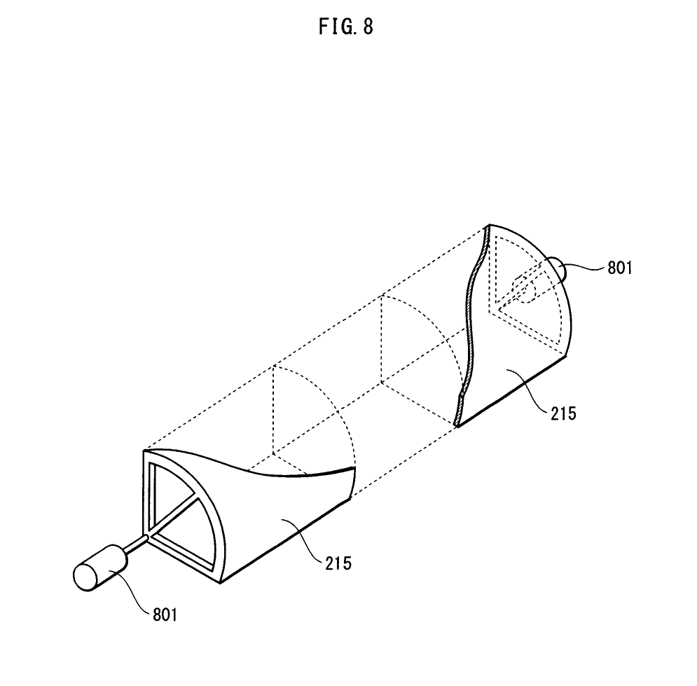

FIG. 8 explains a structure for moving the magnetic flux shielding members 215. As FIG. 8 shows, the magnetic flux shielding members 215 have stepping motors 801 attached thereto, and are rotated by the stepping motors 801.

Besides, FIG. 8 explains a case where the magnetic flux shielding members 215 are two in number and rotated by the stepping motors 801 that are disposed at respective ends of the fixing belt 206. However, the magnetic flux shielding members 215 may not be two in number but may be integrated, and may be rotated integrally only by a single stepping motor 801 that is disposed at one of the ends of the magnetic flux shielding members 215.

(2) Although a specific explanation has not been given in the embodiment above, the magnetic flux shielding members 215 might generate heat by an alternating magnetic flux induced by the excitation coil and greatly increase in temperature. Then surrounding members or the magnetic flux shielding members 215 per se might be deteriorated or broken due to heat.

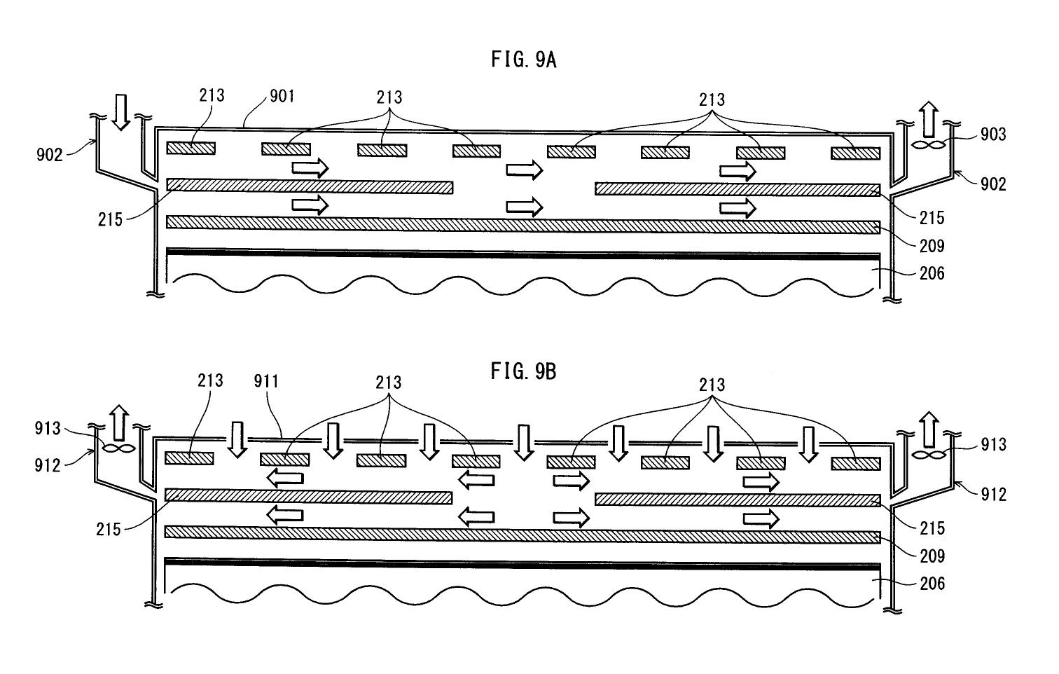

Therefore, it is preferable to cool the magnetic flux shielding members 215 by means of some method. FIG. 9A shows an example of a structure for cooling the magnetic flux shielding members 215 where the air is supplied from one of two ends of the fixing roller 202 in an axial direction thereof, and FIG. 9B shows an example of a structure for cooling the magnetic flux shielding members 215 where the air is supplied from openings of a plurality of main cores 213 that are rib-like.

As FIG. 9A shows, the magnetic flux shielding members 215 and the main cores 213 are housed in a casing 901. In addition, the casing 901 has ducts 902 at both ends thereof in a rotation axial direction of the fixing roller 202. One of the ducts 902 is an exhaust duct for emitting the air inside the fixing apparatus 115 using a fan 903. Also, the other one of the ducts 902 takes the fresh air in the fixing apparatus 115.

According to the structure shown in FIG. 9B, the air is discharged by fans 913 that are disposed at respective ducts 912 disposed at both ends of the housing 901. Also, the fresh air is supplied through the openings of the plurality of main cores 213 that are rib-like, and accordingly cooling efficiency is further increased.

Besides, in both cases, a passage of the air and the fixing belt 206 are separated by the coil bobbin 212, and accordingly the temperature of the fixing belt 206 is not decreased.

With such a structure, it is possible to prevent the overheat of the magnetic flux shielding members 215 and deterioration or failure of the surrounding members due to heat.

(3) According to the above embodiment, the fixing belt 206 is heated by electromagnetic induction. However, it is naturally understood that the present invention is not limited to this. The fixing roller 202 may include a metal heat generating layer and heat the metal heat generating layer by electromagnetic induction without using the fixing belt 206. In both cases, the effect of the present invention is same.
(4) According to the above embodiment, the controller 112 positionally controls the magnetic flux shielding members 215. However, it is naturally understood that the present invention is not limited to this, and the following modification can be made.

That is, a micro processor may be provided to the fixing apparatus and the magnetic flux shielding members 215 may be positionally controlled in accordance with the surface temperature of the fixing belt 206, which has been detected by the infrared sensor 208. In this case, the effect of the present invention is same.

(5) According to the above embodiment, each oblique side of the magnetic flux shielding members 215 is a substantially straight line. However, it is naturally understood that the present invention is not limited to this, and even when the oblique side is a curved line, the same effect can be expected.
(6) According to the above embodiment, the magnetic flux shielding members 215 are reciprocated between the main cores 213 and the center core 209. However, it is naturally understood that the present invention is not limited to this, and the main cores 213 instead of the center core 209 may include a protrusion that conveys a magnetic flux from the center of the excitation coil 207, and the magnetic flux shielding members 215 may be reciprocated between the excitation coil 207 and the protrusion of the main cores 213.

The center of the coil has the highest magnetic flux density. Therefore, regardless of with or without the center core 209, by shielding the center of the coil using the magnetic flux shielding members 215, it is possible to efficiently shield a magnetic flux and achieve the aim of the present invention.

Although a specific explanation has not been given in the embodiment above, the surface temperature of the fixing belt 206 within the third area L3 shown in FIG. 6 may be monitored by a temperature sensor that is not illustrated, and power distribution amount distributed to the excitation coil 207 may be controlled in accordance with the monitored surface temperature such that the temperature of the fixing belt is kept to be appropriate for fixation.

(8) According to the above embodiment, an Ni electroformed sleeve is used as the metal heat generating layer 301. However, it is naturally understood that the present invention is not limited to this, and the following materials may be used. For example, a material for the metal heat generating layer 301 may be SUS (Stainless Used Steel), or a lamination of Ni and Cu. Also, metal such as an Fe—Ni alloy may be used. In any case, the effect of the present invention is same.

### [4] Conclusion

The fixing apparatus that fixes sheets of various sizes characterized in comprising: a fixing rotational body that includes a heat generating layer; an excitation coil having a center hole, is positioned along an axial direction of the fixing rotational body, and is configured to generate a magnetic flux and cause the heat generation layer to generate heat by electromagnetic induction so as to heat the fixing rotational body; magnetic flux shielding members that are positioned outside the excitation coil in a radial direction of the fixing rotational body so as to cover the center hole at a position corresponding to at least one of ends of a maximum sheet passing region of the fixing rotational body in the axial direction, and configured to be movable along the excitation coil; and a controller that is configured to move the magnetic flux shielding members such that when a fed sheet has a smaller width, the center hole of the excitation coil is more widely covered, wherein when a fed sheet has a width smaller than a width of the maximum sheet passing region, a part of a circumferential edge of each of the magnetic flux shielding members in a plan view obliquely crosses with the center hole in the axial direction of the fixing rotational body can effectively prevent overheat of the non sheet passing region, since the magnetic flux shielding members cover at least one of ends of the maximum sheet passing region and when a fed sheet has a width smaller than a width of the sheet passing region, the center hole of the excitation coil is more widely covered. Also, when a fed sheet has a width smaller than a width of the maximum sheet passing region, a part of a circumferential edge of each of the magnetic flux shielding members in a plan view obliquely crosses with the center hole in the axial direction.

Accordingly, it is possible to prevent uneven temperature distribution caused by heat dissipation from the sheet passing region to the non sheet passing region.

Also, such magnetic flux shielding members only have to have a plate-like shape along the excitation coil. Therefore, reduction in size, weight and cost can be realized.

Also, if an elongated core member that is disposed in the center hole of the excitation coil in a direction parallel to the axial direction of the fixing rotational body, and configured to focus the magnetic flux generated by the excitation coil, wherein the core member is out of contact with the magnetic flux shielding members, the magnetic flux is focused by the core member, and accordingly shielding efficiency by the magnetic flux shielding members can be improved.

Also, uneven temperature distribution can be further reduced if the magnetic flux shielding members are two in number, when the excitation coil heats a part of the fixing rotating body, which is smaller than a maximum heating range of the fixing rotating body, the core member in a plan view is divided into three groups of areas: one first area that is not shielded by the magnetic flux shielding members; two second areas that are partially shielded by the magnetic flux shielding members; and two third areas that are completely shielded by the magnetic flux shielding members, and one of the two second areas has a length of 5 to 30 mm inclusive in the axial direction of the fixing rotational body.

In this case, preferably the controller moves the magnetic flux shielding members such that both ends of a fed sheet in the axial direction pass through the respective two second areas, and it is further preferable if the controller moves the magnetic flux shielding members such that each end of the sheet in the axial direction passes through substantially a center of a corresponding one of the two second areas.

Also, a receiver that is configured to receive a size of a fed sheet in the axial direction, wherein the controller moves the magnetic flux shielding members in accordance with the size received by the receiver, and as the received size becomes smaller, the controller moves the magnetic flux shielding members to shield a larger part of the center hole of the excitation coil.

Also, a temperature detector that is disposed at one of the end portions of the maximum sheet passing region, and configured to detect a temperature of the fixing rotational body, wherein the controller moves the magnetic flux shielding members in accordance with the temperature detected by the temperature detector. In this case, preferably, as the detected temperature increases, the controller moves the magnetic flux shielding members to shield a larger part of the center hole of the excitation coil.

Also, if a ventilator that is configured to perform ventilation with fresh air so as to cool the magnetic flux shielding members, it is possible to prevent disadvantages such as failure or deterioration of surrounding members or the magnetic flux shielding members per se due to overheat of the magnetic flux shielding members. In this case, if the ventilator performs the ventilation along a side of the excitation coil that is opposite the fixing rotational body in the radial direction, it is possible to prevent increase of the temperature of the fixing rotational body, and accordingly contribute to reduction in power.

Also, an image forming apparatus including the above fixing apparatus can obviously achieve the above effects.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A fixing apparatus that fixes sheets of various sizes comprising:
a fixing rotational body that includes a heat generating layer;
an excitation coil having a center hole, is positioned along an axial direction of the fixing rotational body, and is configured to generate a magnetic flux and cause the heat generation layer to generate heat by electromagnetic induction so as to heat the fixing rotational body;
magnetic flux shielding members that are positioned outside the excitation coil in a radial direction of the fixing rotational body so as to cover the center hole at a position corresponding to at least one of ends of a maximum sheet passing region of the fixing rotational body in the axial direction, and configured to be movable along the excitation coil; and
a controller that is configured to move the magnetic flux shielding members such that when a fed sheet has a smaller width, the center hole of the excitation coil is more widely covered, wherein
when a fed sheet has a width smaller than a width of the maximum sheet passing region, a part of a circumferential edge of each of the magnetic flux shielding members in a plan view obliquely crosses with the center hole in the axial direction of the fixing rotational body.

2. The fixing apparatus of claim 1, further comprising
an elongated core member that is disposed in the center hole of the excitation coil in a direction parallel to the axial direction of the fixing rotational body, and configured to focus the magnetic flux generated by the excitation coil, wherein
the core member is out of contact with the magnetic flux shielding members.

3. The fixing apparatus of claim 2, wherein
the magnetic flux shielding members are two in number,
when the excitation coil heats a part of the fixing rotating body, which is smaller than a maximum heating range of the fixing rotating body, the core member in a plan view is divided into three groups of areas: one first area that is not shielded by the magnetic flux shielding members; two second areas that are partially shielded by the magnetic flux shielding members; and two third areas that are completely shielded by the magnetic flux shielding members, and
one of the two second areas has a length of 5 to 30 mm inclusive in the axial direction of the fixing rotational body.

4. The fixing apparatus of claim 3, wherein
the controller moves the magnetic flux shielding members such that both ends of a fed sheet in the axial direction pass through the respective two second areas.

5. The fixing apparatus of claim 4, wherein
the controller moves the magnetic flux shielding members such that each end of the sheet in the axial direction passes through substantially a center of a corresponding one of the two second areas.

6. The fixing apparatus of claim 1, further comprising
a receiver that is configured to receive a size of a fed sheet in the axial direction, wherein
the controller moves the magnetic flux shielding members in accordance with the size received by the receiver.

7. The fixing apparatus of claim 6, wherein
as the received size becomes smaller, the controller moves the magnetic flux shielding members to shield a larger part of the center hole of the excitation coil.

8. The fixing apparatus of claim 1, further comprising
a temperature detector that is disposed at one of the end portions of the maximum sheet passing region, and configured to detect a temperature of the fixing rotational body, wherein
the controller moves the magnetic flux shielding members in accordance with the temperature detected by the temperature detector.

9. The fixing apparatus of claim 8, wherein
as the detected temperature increases, the controller moves the magnetic flux shielding members to shield a larger part of the center hole of the excitation coil.

10. The fixing apparatus of claim 1, further comprising
a ventilator that is configured to perform ventilation with fresh air so as to cool the magnetic flux shielding members.

11. The fixing apparatus of claim 10, wherein
the ventilator performs the ventilation along a side of the excitation coil that is opposite the fixing rotational body in the radial direction.

12. An image forming apparatus that fixes sheets of various sizes, comprising
a fixing rotational body that includes a heat generating layer;
an excitation coil having a center hole, is positioned along an axial direction of the fixing rotational body, and is configured to generate a magnetic flux and cause the heat generation layer to generate heat by electromagnetic induction so as to heat the fixing rotational body;
magnetic flux shielding members that are positioned outside the excitation coil in a radial direction of the fixing rotational body so as to cover the center hole at a position corresponding to at least one of ends of a maximum sheet passing region of the fixing rotational body in the axial direction, and configured to be movable along the excitation coil; and
a controller that is configured to move the magnetic flux shielding members such that when a fed sheet has a smaller width, the center hole of the excitation coil is more widely covered, wherein
when a fed sheet has a width smaller than a width of the maximum sheet passing region, a part of a circumferential edge of each of the magnetic flux shielding members in a plan view obliquely crosses with the center hole in the axial direction of the fixing rotational body.
